(19) United States
(12) Patent Application Publication
(10) Pub. No.: US 2021/0030201 A1
(43) Pub. Date: Feb. 4, 2021

(54) A DEVICE FOR AUTOMATING COOKING OF A RECIPE

(71) Applicant: Collin Arumai Harinath MENDONS JEYASEELAN, Tamil Nadu (IN)

(72) Inventor: Collin Arumai Harinath MENDONS JEYASEELAN, Tamil Nadu (IN)

(21) Appl. No.: 16/968,297

(22) PCT Filed: Feb. 8, 2019
(86) PCT No.: PCT/IB2019/051018

§ 371 Date: Aug. 7, 2020

(30) Foreign Application Priority Data
Feb. 8, 2018 (IN) 201841004837

(51) Int. Cl. A47J 36/32; A47J 27/00

(52) U.S. Cl. CPC A47J 36/321; A47J 36/165; A47J 27/00

(57) ABSTRACT

A device for automating cooking of recipes is disclosed. The device 10 includes abase having a heating component 26 as source of heat during cooking, and for placing a cooking container 30; a plurality of containers 12 to hold different ingredients required for cooking, Containers 12 are configured to release a predefined amounts of ingredient held therein for delivery into cooking container 30. A controller is operatively coupled to the heating component 26 and the containers 12 to control heating of cooking container 30 and release of different ingredients from container 12. Controller records various steps and associated parameters, such as temperature, time and quantity of ingredients, involved during manual cooking of a recipe by a user, and plays back the recorded steps to cook the recipe when required. The recording can be done through a sensor 25, which records actions of the user.

### TECHNICAL FIELD

This disclosure generally relates to a cooking appliance, and more particularly to a cooking device that enables automatic cooking by recording instructions or actions of user as he cooks a recipe and playing back the recorded instructions to cook the recipe when required.

### BACKGROUND

Conventionally, people prepare the food everyday using known mechanisms such as using stoves, ovens, wood and so on. With advent of technology, many people have started using devices that are capable of cooking several dishes with ease. However, a user may have to be present at all times to operate the device for cooking a recipe.

Further, it is difficult to operate the device as each and every recipe requires use of different options available in the device. As a result, the user may get confused to use the device. The user may have to invest several hours in training to gain a basic knowledge of operating the device.

In order to overcome above limitations, several advanced cooking appliances are provided with advanced features such as pre-settings for particular food items, to reduce the complexity associated with cooking. For example, a microwave oven provides various pre-settings for heating and re-heating, cooking various foods such as breads, cakes, cookies, fries, etc. Further, such appliances provide user-controllable operations such as a bake setting, a roast setting, a broil setting, temperature and time settings, etc. However, such pre-settings are often limited, inadequate to provide a fully functional cooking appliance, and the user-controllable operations require user interaction and skill. Further, such cooking appliances does not provide options for cooking recipes that requires multiple cooking cycles at various power levels, ingredients at different time intervals, cooking duration, and so forth.

Therefore, there is a need for a device that can record the actions or instructions that the user may use to cook a recipe. The instructions recorded may be played back to replicate the cooking of the recipe with or without intervention of the user.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markus groups used in the appended claims.

### OBJECTS OF THE INVENTION

A general object of the present disclosure is to provide an improved device for automatic cooking.

An object of the present disclosure is to provide a device for automatic cooking that enables a user to operate the device remotely.

Another object of the present disclosure is to provide a device for cooking that records various steps and associated parameters involved during cooking a recipe, and cooks according to the recorded recipe when required.

Another object of the present disclosure is to provide a device for cooking that make sadjustments in the recorded recipe in accordance with prevailing conditions.

Yet another object of the present disclosure is to provide a device for cooking that stores ingredients and releases only the required amounts during cooking.

### SUMMARY

Aspects of the present disclosure relate to a device for automated cooking. In an aspect, the disclosed device enables automated cooking of different recipes that are recorded by the device when a user cooks the device manually. Thus, by cooking a recipe only once on the proposed device, user can cook the same recipe without any manual intervention after loading the ingredients in the device. In another aspect, the user can load the ingredients involved in cooking more than one recipes, and remotely operate the device to cook a chosen recipe in desired amounts/servings at time of his choice.

In an aspect, the proposed cooking device for automating the cooking one or more recipes comprises a base having a heating component working as source of heat during cooking, and configured for placing a cooking container; a plurality of containers, coupled to the base, to hold different ingredients required for the cooking, each of the containers configured to release a predefined amount of the ingredient held in the corresponding container for delivery into the cooking container; and a controller operatively coupled to the heating component and the plurality of containers to control heating of the cooking container and release of different ingredients from the plurality of container.

In an aspect, the controller is configured to record various steps and associated parameters involved during cooking of a recipe by a user, and play back the recorded steps to cook the recipe when required.

In an aspect, the associated parameters recorded by the controller can include one or more of temperature of contents of the cooking container, time from start of cooking when a step out of the various steps is performed by the user, and amount of the ingredients released from the different containers.

In an aspect, the device can includes an interface for the use to input the various steps involved during cooking of a recipe.

In an aspect, for recording the various steps involved in cooking a recipe, the device can include a sensor that is operatively coupled with the controller. The sensor can be configured to capture actions performed by the user at the interface while cooking the recipe.

In an aspect, the sensor can be an image capturing unit, and the images captured by the sensor are processed by the controller to ascertain and record a sequence of the steps performed by the user along with temperature of the contents of the cooking container and the time from start of cooking when the step is performed.

In an alternate implementation, the recording of various steps involved in cooking of a recipe can be done based on actions performed by the controller as a result of each user input at the interface.

In an aspect, the device can include a temperature sensor that is operatively coupled to the controller, The temperature sensor can be a non-contact type thermometer, such as infrared thermometer, that is installed away from the cooking container.

In an aspect, the device can also include a lid for covering the cooking container. The various steps recorded during cooking a recipe can include steps of covering and uncovering of the cooking container.

In an aspect, the device can include a stirrer to stir contents of the cooking container. the stirrer may be the stirrer integrated with the lid or may be separate accessory. The various steps recorded during cooking a recipe can accordingly include step of stiffing of contents of the cooking container along with duration of stiffing.

In an aspect, the device can include a plurality of weight sensors, such that each of the plurality of containers is configured with at least one weight sensor. The plurality of weight sensor can be operatively coupled to the controller to enable the controller to control the amount of ingredients released from the different containers.

In an aspect, the device can also comprise a wireless communication means configured to communicate with one or more of at least one of supplementary appliances and a plurality of like devices.

In an aspect, the communication means can be used to pair with the one or more of the like devices. Pairing of the device with like devices enables the device to operate as a master device and the one or more paired like devices to operate as slave devices. After pairing, the master device can make the paired slave devices to prepare the same recipe as the master device both during the recording and during the play back.

In an aspect, the communication means can also enable the device to make the one or more of supplementary appliances to cook supplementary dishes.

Various objects, features, aspects and advantages of the inventive subject matter will become more apparent from the following detailed description of preferred embodiments, along with the accompanying drawing figures in which like numerals represent like components.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates a device used for cooking a recipe, in accordance with one embodiment of the present disclosure;

FIGS. 2 and 3 illustrate exemplary top view and a side view of the proposes cooking device respectively, in accordance with one embodiment of the present disclosure;

FIG. 4 illustrates a controller, in accordance with one embodiment of the present disclosure;

FIGS. 5 and 6 illustrate exemplary flow diagram for a method for recording the steps involved in cooking a recipe, in accordance with one embodiment of the present disclosure; and

FIG. 7 illustrates an exemplary flow diagram for a method for playing back the steps stored for cooking a recipe, in accordance with one embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

Various terms are used herein. To the extent a term used in a claim is not defined, it should be given the broadest definition persons in the pertinent art have given that term as reflected in printed publications and issued patents at the time of filing.

Embodiments explained herein relate to a device for automating cooking of a recipe. The device comprises a sensor for capturing actions performed by a user while preparing the recipe. The sensor sends signals related to the actions captured to a controller. The controller records a sequence of actions performed by the user and meanwhile measure the quantity of ingredients and stores in a memory. In one example, the controller is configured to receive instructions from the user. Subsequently, the controller stores the instructions in the memory.

After storing the actions or instructions, the controller is configured to execute the instructions stored in the memory in order to repeat or replicate the actions/instructions of the user in preparing the recipe. The device facilitates in automating the cooking of the recipe without or less human intervention.

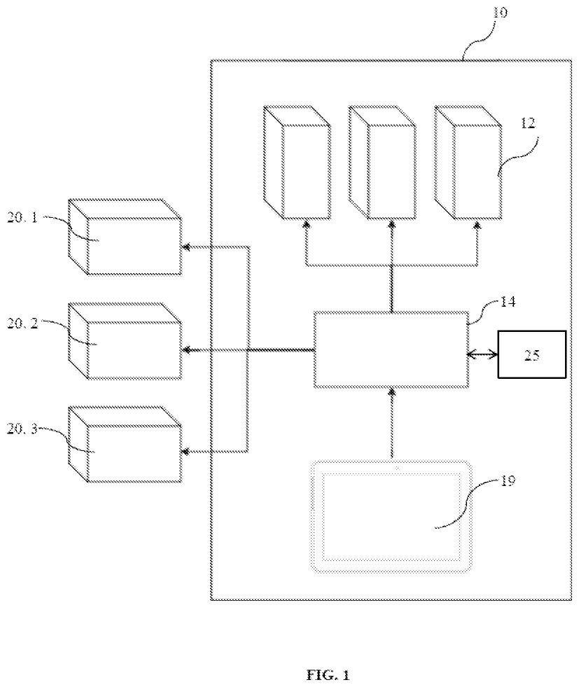

The various implementations of the device for automating cooking of a recipe are explained with the help of FIGS. 1-7.

Referring to FIGS. 1, 2 and 3, a device 10 for automating cooking of a recipe is shown, in accordance with one embodiment of the present disclosure. FIG. 1 shows a schematic diagram of the device 10 used for automating cooking of a recipe. The device 10 comprises a base 11 and a plurality of containers 12. Further, the device 10 comprises a controller 14 for controlling the operations of the device 10. In one example, the controller 14 is operated using an Input/output interface 19. The I/O interface 19 may be provided as an integral component or as an external component to the device 10.

In one implementation, the device 10 may comprise a plurality of supplementary appliances 20.1, 20.2, 20.3 . . . and so on (collectively referred as supplementary appliances 20). The supplementary appliances may include but not limited to a stirrer, a plate, a lid and so on. Furthermore, the device 10 may comprise a sensor 25. In one example, the sensor 25 is an image capturing unit. In one example, the sensor 25 is a motion sensor, which detects movements of the user. In another example, the sensor 25 is configured to detect the actions of a user operating the device 10.

In an alternate implementation, recording of the steps can be done without the sensor 25, i.e. the image capturing unit, based on inputs given by the user at the interface 19, wherein actions performed by the controller 14 as a result of each user input at the interface 19 is recorded as a step along with other parameters such as temperature and time elapsed since start of the cooking.

In an aspect, the I/O interface 19 may include an option to start recording the steps involved in cooking a recipe, and on a user exercising that option, the controller 14 can start recording various actions of the user along with associated parameters, such as temperature of contents of a cooking container, such as cooking container 30, and time from start of cooking at which the step is performed, and the like parameters. Further, when the cooking is complete, the user can exercise another option of stop recording, on which the interface may prompt the user to provide name of the dish prepared and number of servings the prepared dish is sufficient, and store the recipe along with name of the dish and number of servings.

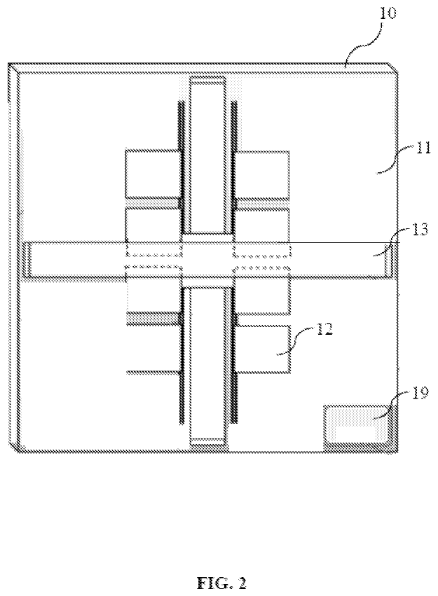

Referring to FIG. 2, a top view of the device 10 is shown, in accordance with one embodiment of the present disclosure. As can be seen, the device 10 comprises a column 13 used to couple the plurality of containers 12. The plurality of containers 12 may be moved horizontally or vertically using the column 13. In one embodiment, the plurality of containers 12 are configured to perform one of releasing the ingredients or processing the ingredients, such as cutting, shredding etc. and then releasing the ingredients upon receiving instructions. The plurality of containers 12 may be, for example, off the shelf containers that can be integrated with the device 10 for performing one or more functions. As such, the user may select one or more types of containers 12 depending on the recipe selected.

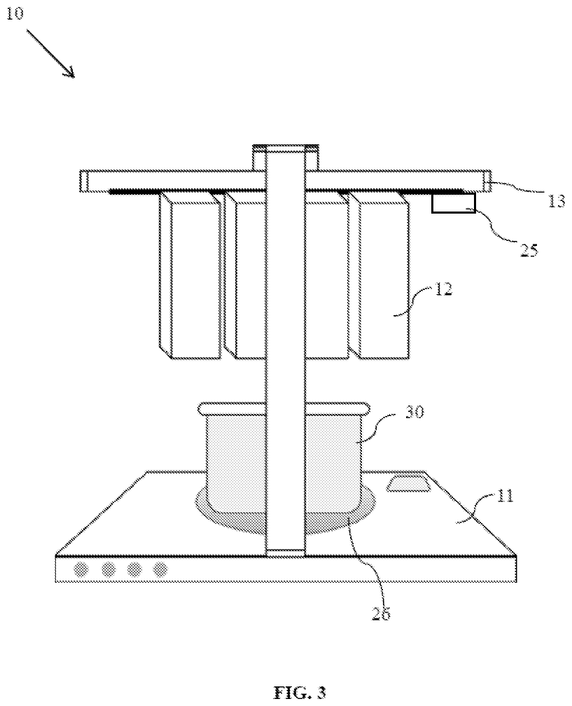

Referring to FIG. 3, a side view of the device 10 is shown, in accordance with one embodiment of the present disclosure. The device 10 comprises a heating component 26 provided at the base 11. The heating component 26 may comprise a stove. Further, the device 10 may comprise a cooking container 30 placed on the heating component 26. As can be seen, the sensor 25 may be placed at the column 13, in accordance with one exemplary implementation of the present disclosure. It should be noted that the placement of the sensor 25 should not be taken in limiting sense and it should be obvious to a person skilled in the art to place the sensor 25 at appropriate place to record actions of the user or receive instructions from the user.

In an implementation, the cooking device 10 can include a temperature sensor to monitor temperature of the contents of the cooking container 30. The temperature sensor can be a non-contact thermometer installed away from the cooking container 30. The non-contact thermometer can be an infrared thermometer which can infer temperature of the contents based on thermal radiation from the contents. The temperature sensor can be operatively coupled to the controller 14 for the controller 14 to monitor and record the temperature during recording the recipe, as well as during automated cooking to ensure that the temperature of the ingredients of the cooking container 30 is in accordance with the desired parameters.

In an aspect, the cooking device 10 can also include a stirring unit and a lid. (Not shown in the figures). The stirring unit and the lid may be mounted on the column 13 and can be configured to move horizontally and vertically, wherein the horizontal movement enables to position them over the cooking container 30 and the vertical movement brings them down in position to carry out stiffing or to cover the cooking container 30 as the case may be. The stiffing unit and a lid may be operatively coupled to the controller 14 so that they may be used when required based on control signals from the controller 14.

In an aspect, each of the plurality of container 12 can be configured with a weight sensor (not shown) so that weight of contents of the container 12 may be ascertained/monitored. The weight sensors may be provided between the respective container 12 and the column 13, and may be operatively coupled with the controller 14. In particular, coupling of the weight sensors with the controller 14 can enable the controller 14 to control amount of ingredients released from the respective container 12 for delivery to the cooking container 30. Thus, the containers 12 may be stocked with excess quantities of the ingredients for multiple cooking of the same recipe or different recipes.

In an aspect, the controller 14 can also be configured to, while replaying the recorded recipe, change the parameters, such as temperature and duration between different steps, depending on its monitoring of the cooking conditions/process. For example, if monitoring of the cooking process reveals that the ingredients have not attained the desired temperature, the controller 14 may wait for more time before taking the next step. In alternate scenario, the controller 14 may reduce the temperature and drop the ingredients in order to avoid food getting burnt.

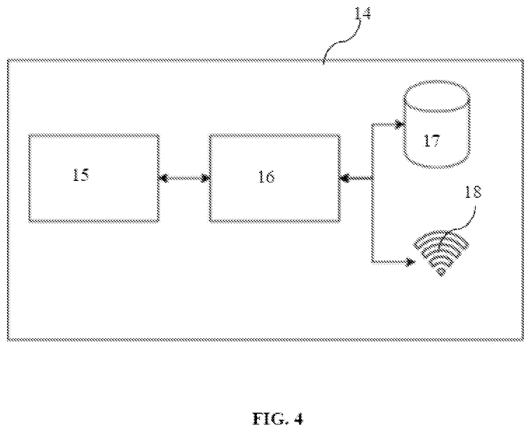

As presented above, the device 10 comprises the controller 14. The controller 14 may comprise an input and output ports 15, a logical unit 16, a memory 17 and a transceiver 18, as shown in FIG. 4. The input and output ports 15 may be used to couple to other devices including but not limited to the plurality of containers 12, the sensor 25 and so on. The logical unit 16 is configured to call and execute the instructions stored in the memory 17. The memory 17 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The transceiver 18 may include a wired or wireless component that is capable of communicating with other components to receive and send signals or instructions. In one example, the transceiver 18 may use Wi-Fi, Bluetooth, LAN or any other known technique to receive and send signals or instructions.

The controller 14 may be implemented as one or more microprocessors, microcomputers, microcontrollers, digital signal processors, central processing units, state machines, logic circuitries, and/or any devices that manipulate signals based on operational instructions. Among other capabilities, the controller 14 is configured to fetch and execute computer-readable instructions stored in the memory 17.

As presented above, the device 10 may be used to record the actions/steps performed by user during cooking a recipe, and to play back the recorded actions to replicate the steps/actions required for cooking the recipe. In implementation, recording of the actions/steps can be done either with the sensor 25, i.e. the image capturing unit, or without the sensor 25 based on inputs given by the user at the interface 19. During recording of the steps based on inputs given by the user at the interface 19, the controller 14 can record the actions performed by it as a result of each user input at the interface 19 as a step along with other parameters such as temperature and time elapsed since start of the cooking.

In an aspect, the disclosed device 10 can include a wireless communication means, which can be configured to communicate with one or more of supplementary appliances and/or with one or more of the like devices 10.

In an aspect, the wireless communication of the device 10 with other like devices 10 enables the device to pair with them. Specifically, the controller 14 of the device 10 can be configured to communicate various steps and the associated parameters to the paired devices 10. Thus, the device 10 communicating the steps and the associated parameters works as a master device, and the paired devices 10, by replicating the same steps and maintain the parameters, work as slave devices. This can be done both during the process of recording or replay/play back to make the slave devices repeat exactly the same steps that are being performed by the master device in real-time. This allows the user to prepare the same recipe simultaneously in multiple devices placed geographically in different locations.

In an aspect, the wireless communication of the device 10 with the supplementary appliances 20, such as but not limited to an external rice cooker, can make the device 10 to instruct the rice cooker to prepare 2 cups of rice while it prepares the recipe. These external devices can be any devices that can receive instructions wirelessly to perform an operation.

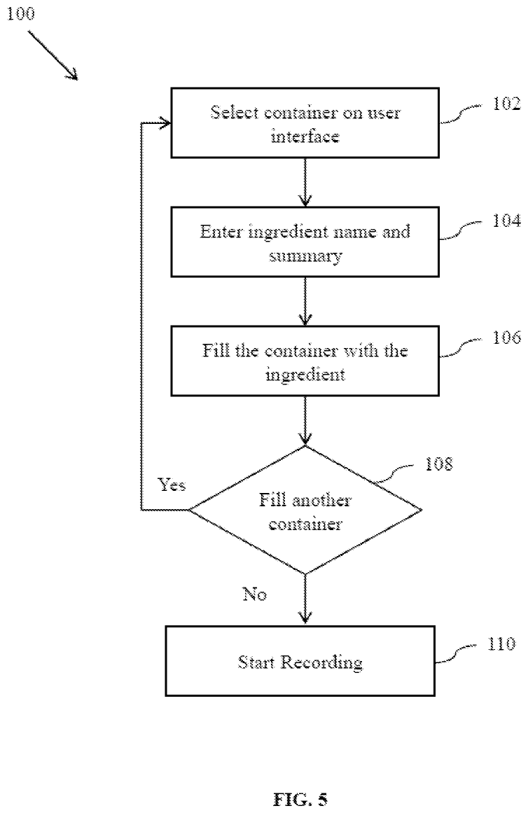

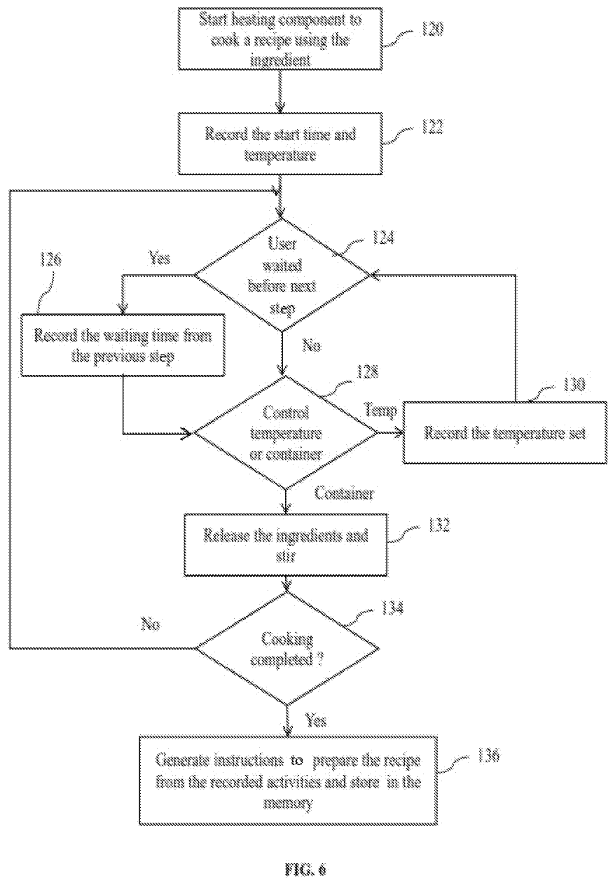

Referring to FIGS. 5 and 6, a method 100 for recording the actions performed by a user for cooking a recipe is explained. In one example, the method 100 is used to receive instructions from the user for cooking a recipe is explained.

It should be understood that the user may have to provide all the ingredients needed for preparing the recipe in the plurality of containers 12. Referring to FIG. 5, at step 102, the user may select at least one container 12 using the I/O interface 19. Specifically, the user selects the container 12 in order to fill ingredients required for cooking the recipe. At step 104, the user enters the details such name of the ingredient and summary of the ingredient in textual form. Subsequently, the device 10 highlights the container 12 selected by the user. For example, a light may be made to blink at the container selected.

At step 106, the user may fill in the respective ingredient into the container 12. At step 108, the device 10 presents a question to the user if he wishes to add another ingredient in another container. If the user wishes to add another ingredient in another container, then the step 102 is repeated. If the user does not wish to add ingredient, then step 110 is performed. At step 110, the device 10 starts to record the actions or instructions of the user.

After initiating the recording of the actions performed by the user, at first, the device 10 initiates the heating component 26. In other words, the user switches ON the heating component 26, as shown at step 120. Subsequently, the device 10 records the start time and the temperature of the heating component 26 such as the stove, as shown at step 122. It should be understood the user prepares the recipe by simply controlling the containers 12 through the I/O interface 19. For example, when the user wanted to release the ingredient from the container 12, the user selects the container 12 in the I/O interface 19 and releases the ingredient from the container 12 into the cooking container 30. During or before releasing the ingredients from the container, the user can control the amount of ingredients which is released from the container to the cooking container 30 through the I/O interface 19. The controller 14 can record the amounts of different ingredients used before dropping them into the cooking container 30.

Based on the instructions received using the I/O interface 19, the controller 14 receives the signal. Subsequently, the controller 14 moves the container 12 coupled to the column 13 in a horizontal or vertical fashion. Further, the container 12 releases the ingredients into the cooking container 30. At the time of cooking the ingredient, the device 10 checks if the user has waited to add another ingredient to the recipe, as shown at step 124. At step 126, the device 10 records the waiting time to add another ingredient. If the user did not wait to add another ingredient to the recipe, then the method 100 proceeds to step 128. At step 128, the device 10 checks the temperature and container based on the ingredients added. At step 130, the device 10 checks the temperature and records the temperature. At step 132, the device 10 releases the ingredients as per the quantity that the user needs to stir in the cooking container 30. And the weight of the released ingredients is measured and recorded. The ingredients are cooked for the time as may be needed by the user. After completion of the cooking (step 134), the device 10 generates the instruction with each and every step and the wait time between each steps as performed by the user. The instructions are stored in the memory 17 or in an external database (not shown) using the transceiver 18.

In one example, the device 10 may employ the sensor 25 to capture the actions of the user at the time of cooking. Further, the controller 14 may record various parameters, such as the temperature, time between each step and the amount of ingredients that has been dropped in to the container. Based on the actions of the user, temperature and the time and the amount of ingredients dropped, the device 10 may generate the instructions and store in the memory 17.

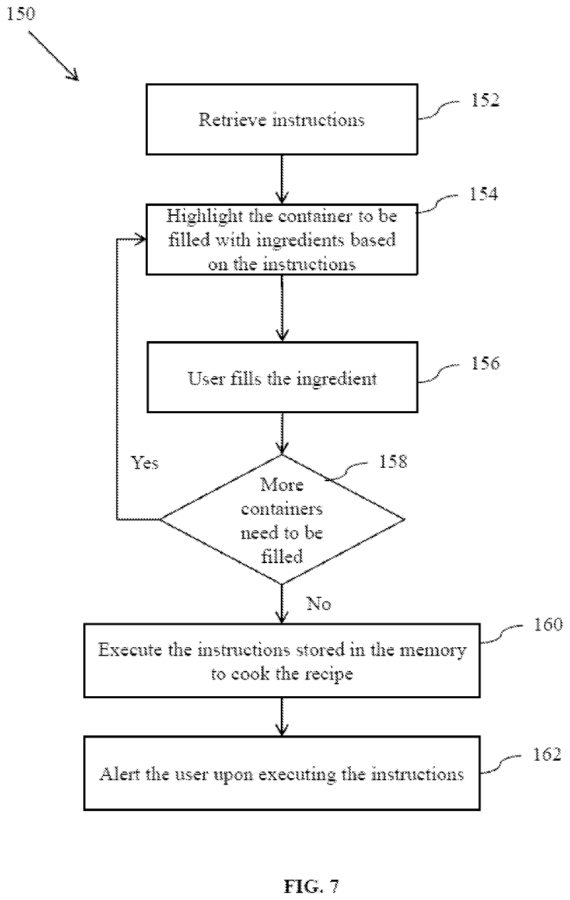

After generating the instructions, the device 10 may be used to replicate the sequence of the steps as performed by the user with or without intervention of the user. Referring to FIG. 7, a method 150 of playing back the instructions to cook the recipe is explained.

At first, the user may select the recipe he intends to cook using the I/O interface 19. The user may select the recipe from the device 10, or from another device, or from internet. As shown at step 152, the device 10 retrieves instructions to cook the recipe. The instructions may include details of the recipe such as name of the recipe and ingredients required for the recipe and the quantity of the ingredients. In one embodiment, the user may optimize or modify the steps of the selected recipe using the I/O interface 19. Based on the instructions stored for the recipe, the device 10 highlights the container 12 to be used for filling the ingredient, as shown at step 154. For example, the device 10 highlights the container 12 with a light indicating that the user uses the ingredient from that container. Further, the device 10 may display the instructions on the I/O interface 19 as entered by the user at the time of recording the steps. The user may read the details about the ingredients from the I/O interface 19 and fill in the ingredient in to the container 12, as shown at step 156.

At step 158 the device 10 checks if more containers are required to cook the recipe selected by the user. If the more containers are to be used, then step 154 is performed. If not, then step 160 is performed. At step 160, the device 10 executes the instructions stored in the memory 17 to cook the recipe. For example, if the user has released a container 12 two minutes after the previous step while recording, the device 10 performs the same operation. The device 10 waits for two minutes and then moves the container 12 to release the ingredient into the cooking container 30.

In an aspect, while the device 10 generally follows the recorded sequence and executes each and every step as available in the instruction including the waiting time between each step, it also monitors cooking condition and process and may change the parameters, such as temperature and duration between different steps, depending on its monitoring of the cooking conditions/process. For example, if monitoring of the cooking process reveals that the ingredients have not attained the desired temperature, the controller 14 may wait for more time before taking the next step. In alternate scenario, the controller 14 may reduce the temperature and drop the ingredients in order to avoid food getting burnt.

After executing the instructions, the device 10 may alert the user about the completion of cooking through a sound and/or through electronic message and stops the entire cooking process, as shown at step 162.

It should be understood that the device can be used by user for cooking a recipe. At the time of cooking, the device records the steps performed by the user and stores it as instructions. The recorded instructions can later be replayed by the user to prepare the same recipe again. The device prepares the selected recorded recipe and gets it ready automatically. The instructions stored for preparing the recipe may be transmitted to other devices using the transceiver 18.

It should be understood that the device may be used to record the instructions provided by the user for cooking a recipe using the ingredients and containers. In order to replay or replicate at a later time, the user may fill the ingredients in the containers and set a start time to initiate the cooking by the device without further involvement by him.

In one exemplary implementation, the user may operate the device remotely. In order to operate the device remotely, at first, the user may fill the ingredients in the containers. Subsequently, the user may provide the instructions remotely from other device. The device may receive the instructions via the transceiver and execute the instructions stored in the memory.

In yet another exemplary implementation, the instructions stored in the memory of the device may be shared with other devices (peer devices) for cooking a recipe. For instance, the instructions provided in one device during recording or during replay may be shared with two or more devices such that the recipe can be prepared at each of the devices parallelly at the same time.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Invention

The present disclosure provides an improved cooking device for automatic cooking.

The present disclosure provides a device for automatic cooking that enables a user to operate the device remotely.

The present disclosure provides a device for cooking that records various steps and associated parameters involved during cooking a recipe, and cooks according to the recorded recipe when required.

The present disclosure provides a device for cooking that makes adjustments in the recorded recipe in accordance with prevailing conditions.

The present disclosure provides a device for cooking that stores ingredients and releases only the required amounts during cooking.

I claim:

1. A cooking device for cooking in accordance with one or more recipes, the device comprising:
a base having a heating component working as source of heat during cooking, and configured for placing a cooking container;
a plurality of containers, coupled to the base, to hold different ingredients required for the cooking, each of the containers configured to release a predefined amount of the ingredient held in the corresponding container for delivery into the cooking container; and
a controller operatively coupled to the heating component and the plurality of containers to control heating of the cooking container and release of different ingredients from the plurality of container;
wherein the controller is configured to record various steps and associated parameters involved during cooking of a recipe by a user, and play back the recorded steps to cook the recipe when required.

2. The device as claimed in claim 1, wherein the associated parameters recorded by the controller includes one or more of temperature of contents of the cooking container, time from start of cooking when a step out of the various steps is performed by the user, and amount of the ingredients released from the different containers.

3. The device as claimed in claim 2, wherein the device includes an interface for the use to input the various steps involved during cooking of a recipe.

4. The device as claimed in claim 3, wherein the device includes a sensor that is operatively coupled with the controller; and wherein the sensor is configured to capture actions performed by the user at the interface while cooking the recipe.

5. The device as claimed in claim 4, wherein the sensor is an image capturing unit, and the images captured by the sensor are processed by the controller to ascertain and record a sequence of the steps performed by the user along with temperature of the contents of the cooking container and the time from start of cooking when the step is performed.

6. The device as claimed in claim 2, wherein the device includes a temperature sensor that is operatively coupled to the controller, and wherein the temperature sensor is a non-contact type infrared thermometer installed away from the cooking container.

7. The device as claimed in claim 1, wherein the device includes a lid for covering the cooking container, and the various steps recorded during cooking a recipe includes steps of covering and uncovering of the cooking container.

8. The device as claimed in claim 7, wherein the device includes a stirrer to stir contents of the cooking container, and the various steps recorded during cooking a recipe includes step of stiffing of contents of the cooking container along with duration of stiffing.

9. The device as claimed in claim 8, wherein the stirrer is integrated with the lid.

10. The device as claimed in claim 3, wherein the recording of various steps involved in cooking of a recipe is done based on actions performed by the controller as a result of each user input at the interface.

11. The device as claimed in claim 2, wherein the device includes a plurality of weight sensors, such that each of the plurality of containers is configured with at least one weight sensor, and wherein the plurality of weight sensor are operatively coupled to the controller to enable the controller to control the amount of ingredients released from the different containers.

12. The device as claimed in claim 1, wherein the device comprises a wireless communication means configured to communicate with one or more of at least one of supplementary appliances and a plurality of like devices.

13. The device as claimed in claim 12, wherein the communication means enables the device to pair with the one or more of the like devices, wherein pairing enables the device to operate as a master device and the one or more paired like devices to operate as slave devices; and wherein the master device makes the paired slave devices to prepare the same recipe as the master device both during the recording and during the play back.

14. The device as claimed in claim 12, wherein the communication means enables the device to make the one or more of supplementary appliances to cook supplementary dishes.
